(19) United States
(12) Patent Application Publication
(10) Pub. No.: US 2015/0336711 A1
(43) Pub. Date: Nov. 26, 2015

(54) PURSE SCRIPTIONS MEDICATION CONTAINER

(71) Applicants: Michelle Schlumpberger, Canyon City, CA (US); Kevin Schlumpberger, Canyon City, CA (US)

(72) Inventors: Michelle Schlumpberger, Canyon City, CA (US); Kevin Schlumpberger, Canyon City, CA (US)

(21) Appl. No.: 14/722,127

(22) Filed: May 26, 2015

Related U.S. Application Data
(60) Provisional application No. 62/002,670, filed on May 23, 2014.

(51) Int. Cl. B65D 21/02; B65D 50/00; B65D 25/20; A61J 1/03

(52) U.S. Cl. CPC B65D 21/0223; A61J 1/03; B65D 50/00; B65D 25/20

(57) ABSTRACT

A set of stackable medicine containers that connect into one cohesive container, ensuring medicine is easily accessible and manageable.

### CLAIM OF PRIORITY

This patent application claims priority under 35 USC 119 (e) (1) from U.S. Provisional Patent Application Ser. No. 62/002,670 filed May 23, 2014, of common inventorship herewith entitled, “Purse Scriptions Medication Container,” which is incorporated herein by reference as though the same were set forth in its entirety.

### FIELD OF THE INVENTION

The present invention pertains to the field of oral medications, and more specifically to the field of oral medication containers.

### BACKGROUND OF THE INVENTION

The prior art has put forth several designs for oral medication containers. Among these are:

U.S. Pat. No. 5,312,011 to Dan E. Fischer describes a stackable container system having a plurality of individual containers wherein each container is snapped onto and securely fastened to another similarly configured container. Each container has a lid securely tethered to the side of the container by an integrally molded strap such that the lids of the individual containers are not lost or misplaced. The container lids are configured so as to securely engage the container sidewall by a snap fit design having a conveniently placed thumb tab to facilitate the quick and easy release of the lid. A removable divider is positioned within each container receptacle to compartmentalize the receptacle such that individual component parts are storable in a single container without becoming mixed or interspersed during storage. Each container of the stackable system comprises a transparent material for the visual inspection of the contents contained therein prior to opening the container. The containers are individually color coded for easier and quicker identification of any one container comprising the stackable system.

U.S. Pat. No. 4,485,923 to Ralph A. Schwaikert describes a stackable, closable container with a generally cylindrical body portion and generally circular top and bottom end walls. The container has an opening at its top end wall and is plugged with a resiliently flexible cover. In a preferred embodiment, the cover acts as a child resistant closure. The cover also acts as a female member which receives a male member on the bottom end of an identical container stacked above it. The weight of the top container, however, is supported by the raised flange on the top end wall of the container beneath it, such such that the lids of the individual containers are not lost or misplaced. The container lids are configured so as to securely engage the container sidewall by a snap fit design having a conveniently placed thumb tab to facilitate the quick and easy release of the lid. A removable divider is positioned within each container receptacle to compartmentalize the receptacle such that individual component parts are storable in a single container without becoming mixed or interspersed during storage. Each container of the stackable system comprises a transparent material for the visual inspection of the contents contained therein prior to opening the container. The containers are individually color coded for easier and quicker identification of any one container comprising the stackable system.

U.S. Pat. No. 4,485,923 to Ralph A. Schwaikert describes a stackable, closable container with a generally cylindrical body portion and generally circular top and bottom end walls. The container has an opening at its top end wall and is plugged with a resiliently flexible cover. In a preferred embodiment, the cover acts as a child resistant closure. The cover also acts as a female member which receives a male member on the bottom end of an identical container stacked above it. The weight of the top container, however, is supported by the raised flange on the top end wall of the container beneath it, such that no weight is supported by the closure itself. The top raised flange of the container and its bottom chime extend outwardly approximately an equal distance such that when one container is adjacent to an identical container in a side by side relationship there is a space between the containers so as to avoid scuffing of the containers or labels affixed thereto.

U.S. Pat. No. 3,739,939 to Elmer A. Koenig describes a stackable container for medicaments having continuous side walls tapering downwardly from an open end toward a bottom surface. The side walls integrally contain positive locking means, ensuring that similar containers are lockable securely to each other with a predetermined amount of force, while simultaneously maintaining uniform spacing between the side walls and bottoms of the nested containers.

None of these prior art references describe the present invention.

### SUMMARY OF THE INVENTION

It is an object of the present invention to provide a set of stackable medicine bottles that connect into one cohesive container, ensuring medicine is easily accessible and manageable.

### BRIEF DESCRIPTION OF THE DRAWINGS

FIG. 1 is an illustrative prototypical top down view showing a security clip, child proof cap, stackable bottom, and clear cylindrical container.

FIG. 2 is an illustrative prototypical top down view showing two bottles of different colors for differentiating medications.

FIG. 3 is an illustrative prototypical top down view showing two bottles connected together, one bottle stacked above the other bottle.

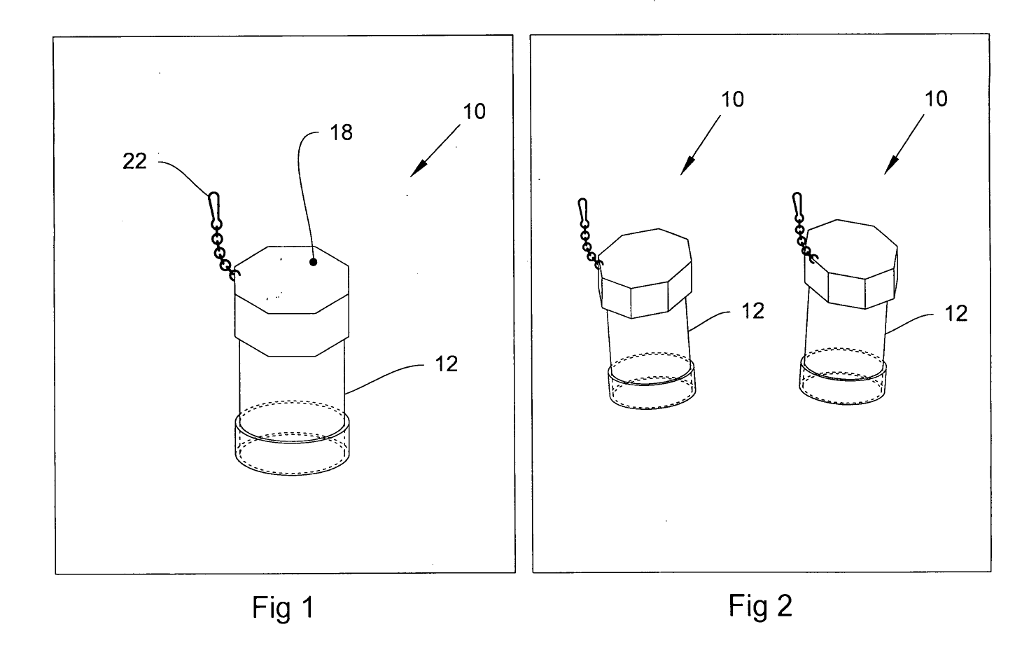

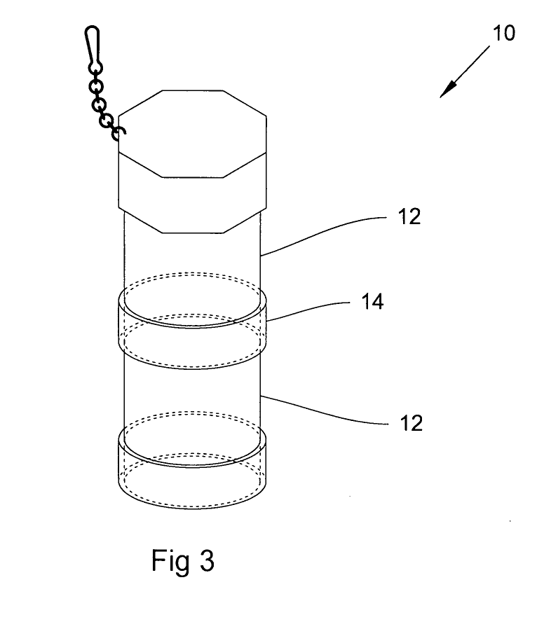

### DETAILED DESCRIPTION OF THE INVENTION

Every day millions of people are prescribed a variety of medications by their medical doctors. Whether antibiotics for a temporary malady such as the flu or refills on pills to keep the blood pressure in check, doctor prescribed medicines are necessary for continued good health and well being. As the population ages, the amount of medications an individual takes often begins to increase along with their years. Polypharmacy, defined as concurrent use of multiple medications by a single patient, may occur in all age groups, but is an especially common occurrence among the elderly population. In recent medical studies, patients who are age sixty five and older use an average of two to six prescribed medications on a regular basis. Having to use so many different medicines, it is quite a chore for people to keep track of the various containers that litter bathroom counters and bedside tables or have sunk to the bottom of one's purse or briefcase. Sorting through multiple bottles, finding a needed medication becomes a time consuming process for many. Whether digging through a purse, perusing a gym bag or fruitlessly investigating dresser drawers, it is common for someone on several medications to easily come across allergy and arthritis pills when what they need most is blood pressure medicine. Clusters of pill containers are knocked about when trying to access one and simple hand motions easily spill over lightweight bottles. An annoying and frustrating battle to right them again, and pick up any pills that have spilled onto the floor, often ensues.

The present invention, hereinafter referred to as Purse Scriptions Medication Container, or simply Purse Scriptions, is an organizational system 10 for prescription and over the counter medications that is comprised of stackable medicine bottles that are easily affixed to one another. Purse Scriptions provide consumers with an easy and convenient means of organizing and storing multiple medications as well as accessing these medications when needed. Purse Scriptions provide a convenient solution to some of the problems faced by patients who are required to take multiple medications on a regular basis.

Comprised primarily of plastic components, Purse Scriptions are a series of cylindrically shaped containers 12 having an octagonal cross-section that are stackable and joined together with integrated fittings located on the container caps 14 and base of each bottle respectively. Purse Scriptions are available as an aftermarket accessory to be filled with existing medications or are available for use by pharmacies, hospitals and other dispensaries of prescription and over the counter medications. Each Purse Scription is a cylindrical octagonally shaped receptacle 12 measuring approximately one and one half to two inches in total length and one and one half to two inches in diameter. Purse Scriptions contain a specially designed child proof cap 18, the surface of which comprises a series of male fittings that interlock with female fittings located on the underside of each bottle. Each cap 18 is affixable to an upper adjacent bottle in a similar manner as two toy building blocks are secured together. The cap 18 can be made of glow in the dark material to facilitate finding the container in a dark purse. The uppermost cap 18 in each set of Purse Scriptions contains a sturdy, spring loaded clip 22 for use in securing the device to the zippered compartments in purses, briefcases and backpacks. This clip fastener 22 also is utilized to hang the stacked Purse Scriptions within a bathroom vanity, medicine cabinet or other easily accessed location. Purse Scriptions are color coded to easily organize one's medications. Purse Scriptions are produced in packages comprising five interlocking medicine bottles and caps.

Application and use of Purse Scriptions is simple and straight forward. First, a user collects their existing prescription and over the counter medications taken on a daily basis, transferring these medications to Purse Scription containers. As these bottles are color coded, the user easily organizes their medication, placing heart medication in a red bottle and allergy medication in a green bottle. For safety purposes, the user also removes the existing label from their prescription medication, inserting the label into the corresponding Purse Scription bottle. The user then fills the bottle with the designated medication-. This process is repeated until all bottles have been filled and capped. Next, the user stacks one bottle atop the next bottle, inserting protrusive male fittings located on the top of each cap into recessive female fittings located on the underside of each bottle. With Purse Scriptions filled, the user secures the present invention in their purse, briefcase or medicine cabinet utilizing the spring loaded clip fastener. To retrieve their medication, the user grasps Purse Scriptions and opens each bottle containing a medication to be taken on a daily basis. After taking a medication, the user closes the designated Purse Scriptions' bottle and locks it back into the stack. Purse Scriptions are stored away until time to take the next dosage of medicine.

Purse Scriptions are stackable medicine bottles easily connected together to form one cohesive unit and ensure that one's needed medicine is easily accessible and manageable on demand. Eliminating the need to search high and low for certain pill bottles, users locate and access their medication in a matter of seconds. Made of durable, high quality materials, the present invention will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A set of stackable medicine containers that connect into one cohesive container, ensuring medicine is easily accessible and manageable, comprising: a series of cylindrically shaped containers having an octagonal cross-section, wherein the containers are stackable and joined together with integrated fittings located on the container caps and base of each bottle respectively.

2. The set stackable medicine containers of claim 1, wherein each container measures approximately one and one half to two inches in total length and one and one half to two inches in diameter.

3. The set stackable medicine containers of claim 1, wherein each container comprises a specially child proof cap.

4. The set stackable medicine containers of claim 1, wherein each cap is affixable to an upper adjacent container.

5. The set stackable medicine containers of claim 1, wherein a cap is made of glow in the dark material.

6. The set stackable medicine containers of claim 1, wherein an uppermost cap comprises a sturdy, spring loaded clip for use in securing the device to the zippered compartments in purses, briefcases and backpacks.

7. The set stackable medicine containers of claim 1, wherein each container in the set is a different color.

8. The set stackable medicine containers of claim 1, produced in a package comprising five interlocking containers.
